(19) United States
(12) Patent Application Publication
(10) Pub. No.: US 2025/0190005 A1
(43) Pub. Date: Jun. 12, 2025

(54) Current driver for display panel

(71) Applicant: NOVATEK Microelectronics Corp., Hsin-Chu (TW)

(72) Inventors: Ren-Chieh Yang, Hsinchu County (TW); Jui-Chan Chang, Hsinchu City (TW); Jin-Yi Lin, Kaohsiung City (TW); Jhih-Siou Cheng, New Taipei City (TW)

(73) Assignee: NOVATEK Microelectronics Corp., Hsin-Chu (TW)

(21) Appl. No.: 18/830,596

(22) Filed: Sep. 11, 2024

Related U.S. Application Data
(60) Provisional application No. 63/607,062, filed on Dec. 6, 2023.

(51) Int. Cl. G05F 3/26; G02F 1/1335; G02F 1/13357; G09G 3/34; H05B 45/30

(52) U.S. Cl. CPC G05F 3/262; G09G 3/3406; H05B 45/30; G02F 1/133603; G02F 1/133612

(57) ABSTRACT

A current driver having an input channel and an output channel includes a current source, a current mirror, an output enable switch and a control circuit. The current source is deployed in the input channel. The current mirror is deployed between the input channel and the output channel and coupled to the current source. The output enable switch is deployed in the output channel and coupled to the current mirror. The control circuit is coupled between the input channel and the output channel, to form a feedback loop through the input channel.

### CROSS REFERENCE TO RELATED APPLICATIONS

This application claims the benefit of U.S. Provisional Application No. 63/607,062, filed on Dec. 6, 2023. The content of the application is incorporated herein by reference.

### BACKGROUND OF THE INVENTION

### 1. Field of the Invention

The present invention relates to a current driver, and more particularly, to a current driver for driving a display panel.

### 2. Description of the Prior Art

Based on the requirements of display quality, various display technologies arise correspondingly, such as the liquid crystal display (LCD) and organic light emitting diode (OLED) display. In the LCD, the images are shown by using liquid crystal molecules to adjust the aperture ratio, where light emission is generated by using a backlight module and the color is determined by using a color filter. A direct backlight module has become the mainstream of the backlight scheme of the LCD panel. This is because the direct backlight module has the features of high contrast and low leakage light, and is capable of local dimming operations to reduce power consumption. The direct backlight module may include multiple light emitting diode (LED) strings deployed under the LCD pixels, where each LED string may be driven by a driver circuit; that is, the driver circuit supplies currents to the LED string of the backlight module to drive the LEDs to emit light, so as to generate the light emission of the LCD panel.

In recent years, the resolution and refresh rate of the LCD panel rise gradually; hence, the current for driving the LEDs in the backlight module is requested to be operated faster. In the driver circuit, an operational amplifier (op-amp) is implemented to generate a driving current to be supplied to the LED string. The op-amp is configured to control an output device to enable and adjust the driving current, to be adaptive to the required backlight control scheme for the backlight module. However, the LED string usually has a great number of LEDs spread over the whole panel, and the LEDs are requested to generate high brightness; hence, the LED string should receive a high voltage supply. In order to drive the high-voltage LED string, the output device should be a high-voltage device such as a high-voltage transistor. The high-voltage device is capable of tolerating the high supply voltage of the LED string, and may be manufactured by using an additional process step, which requires a higher circuit cost and possesses a larger load. Since the op-amp is requested to drive the high-voltage device, the reaction speed of the op-amp is limited.

### SUMMARY OF THE INVENTION

It is therefore an objective of the present invention to provide a novel current driver for driving a display panel, in order to solve the abovementioned problems.

An embodiment of the present invention discloses a current driver having an input channel and an output channel. The current driver comprises a current source, a current mirror, an output enable switch and a control circuit. The current source is deployed in the input channel. The current mirror is deployed between the input channel and the output channel and coupled to the current source. The output enable switch is deployed in the output channel and coupled to the current mirror. The control circuit is coupled between the input channel and the output channel, to form a feedback loop through the input channel.

Another embodiment of the present invention discloses a current driver having an input channel and an output channel. The current driver comprises a current source, an input control transistor, a current mirror, an output enable switch and a first operational amplifier. The current source is deployed in the input channel. The input control transistor is deployed in the input channel and coupled to the current source. The current mirror is deployed between the input channel and the output channel and coupled to the input control transistor. The output enable switch is deployed in the output channel and coupled to the current mirror. The first operational amplifier comprises a first input terminal, a second input terminal and an output terminal, wherein the first input terminal is coupled to the output channel, the second input terminal is coupled to the input channel, and the output terminal is coupled to the input control transistor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a two-stage current driver.

FIG. 2 is a schematic diagram of a three-stage current driver.

FIG. 3 is a schematic diagram of a current driver according to an embodiment of the present invention.

FIG. 4 illustrates a detailed implementation of the current driver.

FIG. 5 illustrates another detailed implementation of the current driver.

FIG. 6 illustrates a further detailed implementation of the current driver.

### DETAILED DESCRIPTION

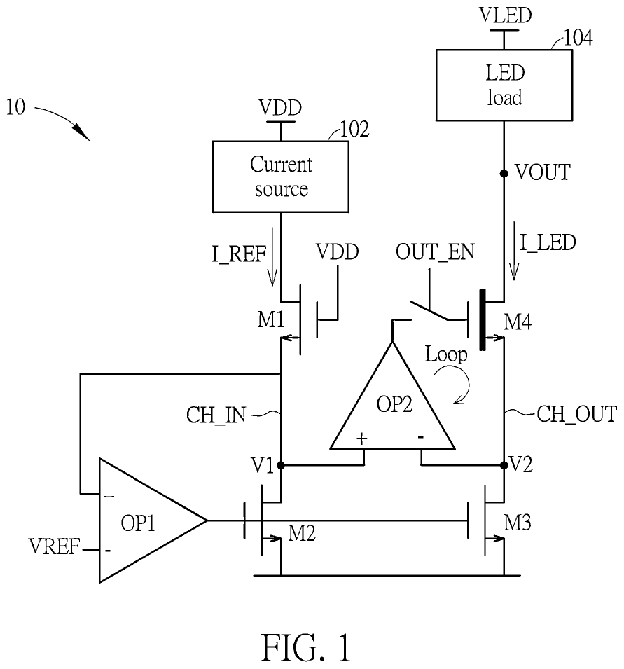

There are two driving schemes used in the current driver for driving the light emitting diode (LED) strings in the backlight module of the liquid crystal display (LCD):the two-stage scheme and three-stage scheme. FIG. 1 is a schematic diagram of a two-stage current driver 10. The two-stage current driver 10 includes a current source 102, transistors M1-M4, and operational amplifiers (op-amps) OP1 and OP2. An LED load 104 driven by the two-stage current driver 10 is also shown in FIG. 1 to facilitate the illustrations.

The two-stage current driver 10 may include an input channel CH_IN and an output channel CH_OUT, where the current source 102 and the transistors M1 and M2 are in the input channel CH_IN, and the transistors M3 and M4 are in the output channel CH_OUT. The current source 102 is configured to generate a reference current I_REF in the input channel CH_IN by receiving a power supply voltage VDD. The op-amp OP1 may appropriately control the operating voltage of the input channel CH_IN, e.g., control a voltage V1 of the input channel CH_IN to be equal to a reference voltage VREF. The transistors M2 and M3 may form a current mirror to generate a driving current I_LED according to the reference current I_REF based on the control of the op-amp OP2. More specifically, the output terminal of the op-amp OP2 is coupled to the gate terminal of the transistor M4, and the source terminal of the transistor M4 is further coupled to the negative input terminal of the op-amp OP2, to form a feedback loop. The feedback loop controls the voltage V2 to track the voltage V1, allowing the voltage V2 to be approximate to the voltage V1 as the feedback loop becomes stable. In such a situation, the current mirror formed by the transistors M2 and M3 may generate the accurate driving current I_LED. With appropriate design of the current mirror, the driving current I_LED for driving the LED load 104 may accurately become a specific multiple of the reference current I_REF.

In addition, the transistor M4 is further controlled by an output enable signal OUT_EN, which may be generated from a pulse width modulation (PWM) controller, to enable the output of the driving current I_LED with a well-controlled duty cycle, so as to control the brightness of the LED string. The transistor M4 is coupled to the LED string. Since the LED strings of the LED load 104 are supplied by a high power supply voltage VLED (which may be far higher than the power supply voltage VDD of the integrated circuit (IC) that used to implement the current driver 10), the transistor M4 should be implemented as a high-voltage device tolerable to the high power supply voltage VLED of the LED load 104.

However, since the transistor M4 is a high-voltage device that may have a larger load, a longer time is required to make the feedback loop stable; that is, the op-amp OP2 has to consume a great amount of time to drive the voltage V2 to reach its target value. As mentioned above, the resolution and refresh rate of the LCD panel rise gradually. With the increasing resolution and/or refresh rate, the scan time usable for each row of pixels is reduced; that is, the scan speed requirement for a row of pixels is increased. Since the op-amp OP2 of the two-stage current driver 10 is requested to drive the high-voltage transistor M4, the reaction speed of the op-amp OP2 may not be enough to support the increasing scan speed requirement.

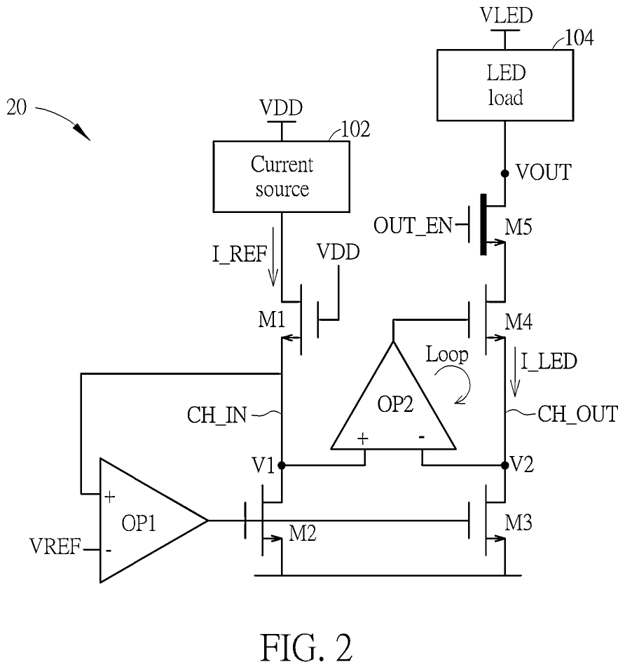

Therefore, the three-stage driving scheme is applied to solve this problem. FIG. 2 is a schematic diagram of a three-stage current driver 20. The circuit structure of the three-stage current driver 20 is similar to the circuit structure of the two-stage current driver 10, so signals and elements having similar functions are denoted by the same symbols. The difference between the three-stage current driver 20 and the two-stage current driver 10 is that, the three-stage current driver 20 further includes an output transistor M5 to be coupled to the LED load 104.

More specifically, in the three-stage current driver 20, the output terminal of the op-amp OP2 is still coupled to the gate terminal of the transistor M4, to form a feedback loop through the transistor M4 and the output channel CH_OUT. The output transistor M5, which is coupled between the transistor M4 and the LED load 104, may form an additional stage to realize the three-stage structure. The output transistor M5 receives the output enable signal OUT_EN, which enables the output of the driving current I_LED with a well-controlled duty cycle. Since the output transistor M5 is coupled to the LED load 104, it may be implemented as a high-voltage device.

On the other hand, the transistors M1-M4 may be implemented as low-voltage or mid-voltage devices. In such a situation, the feedback loop formed by the op-amp OP2 and the transistor M4 will not face the large LED load 104, where the load of the transistor M4 is far smaller than the load of the high-voltage transistor M5. Therefore, the reaction speed of the op-amp OP2 for making the loop stable in the three-stage current driver 20 will be faster than in the two-stage current driver 10. Since the feedback loop becomes stable rapidly, the driving current I_LED in the output channel CH_OUT may rapidly reach its target level.

In this example, the transistor M5 is controlled by the output enable signal OUT_EN to serve as a pure switch. The output enable signal OUT_EN is a digital signal, which transits from low to high rapidly, and thus the transistor M5 is turned on faster than the turn-on speed of the transistor M4 in the two-stage current driver 10. For example, the two-stage current driver 10 may consume a processing time of one or several microseconds to make the driving current I_LED ready after its output transistor M4 is turned on by the output enable signal OUT_EN, while the three-stage current driver 20 may only need hundreds of nanoseconds to make the driving current I_LED ready.

Although the three-stage current driver 20 has a faster operational speed, it includes one more transistor as compared to the two-stage current driver 10. In addition, the output voltage VOUT of the current driver should be as low as possible when the currents are output, to reduce the power consumption of the current driver. In order to maintain the minimum operable voltage level of VOUT, the circuit areas of the transistors M4 and M5 in the three-stage current driver 20 should be far greater than the circuit area of the transistor M4 in the two-stage current driver 10. In order to solve this problem, the present invention provides a novel current driver having the benefits of both the two-stage current driver and the three-stage current driver. More specifically, in the current driver of the present invention, the circuit area may be as small as the circuit area of the two-stage current driver, and the operational speed may be as fast as or even faster than the speed of the three-stage current driver.

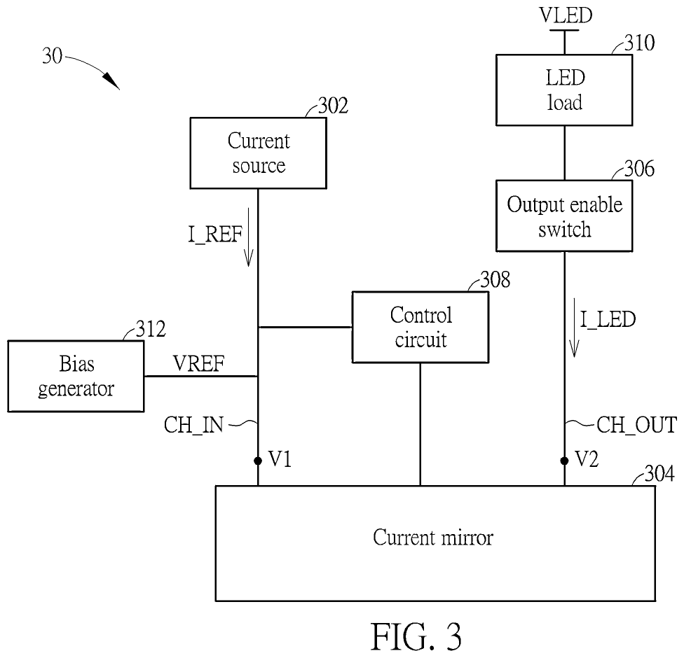

FIG. 3 is a schematic diagram of a current driver 30 according to an embodiment of the present invention. The current driver 30 includes a current source 302, a current mirror 304, an output enable switch 306, a control circuit 308 and a bias generator 312. An LED load 310 to be driven by the current driver 30 is also shown in FIG. 3 to facilitate the illustrations. The LED load 310 may include one or more LED strings deployed in a display panel (e.g., in the backlight module of an LCD panel). The current driver 30 is configured to output a driving current I_LED to drive the LED load 310. In an embodiment, the driving current I_LED may serve as a sink current flowing through the LED string(s) of the LED load 310 to control the LEDs to perform light emission.

In detail, the current driver 30 may have an input channel CH_IN and an output channel CH_OUT. The current source 302 is deployed in the input channel CH_IN and configured to generate a reference current I_REF (or called a seed current) in the input channel CH_IN. In an embodiment, the current source 302 may be a constant current source capable of supplying an accurate and constant current.

The current mirror 304, which is deployed between the input channel CH_IN and the output channel CH_OUT, is configured to generate a driving current I_LED according to the reference current I_REF. More specifically, the current mirror 304 may mirror the reference current I_REF to generate the driving current I_LED to be output to the LED load 310. In an embodiment, the current mirror 304 may amplify the reference current I_REF by a specific ratio to generate the driving current I_LED.

The output enable switch 306, which is deployed in the output channel CH_OUT, is configured to enable the output of the driving current I_LED to the LED load 310. Similarly, since the output enable switch 306 is used to drive the LED load 310 having a high power supply voltage VLED, it may be implemented with a high-voltage device such as a high-voltage transistor.

The control circuit 308, which is coupled between the input channel CH_IN and the output channel CH_OUT, may perform a feedback control that allows the current mirror 304 to generate the accurate driving current I_LED. In this embodiment, a feedback terminal of the control circuit 308 may be connected to the input channel CH_IN, in order to form the feedback loop through the input channel CH_IN. The control circuit 308 may be implemented by using an op-amp or any other circuitry having feedback control functions, which will be detailed in the following paragraphs.

The bias generator 312, which is coupled to the input channel CH_IN, may supply a reference voltage VREF to the input channel CH_IN. The bias generator 312 is configured to control the bias voltage of the input channel CH_IN, allowing the circuit elements in the input channel CH_IN (including the current source 302 and the current mirror 304) to operate normally to generate the accurate reference current I_REF.

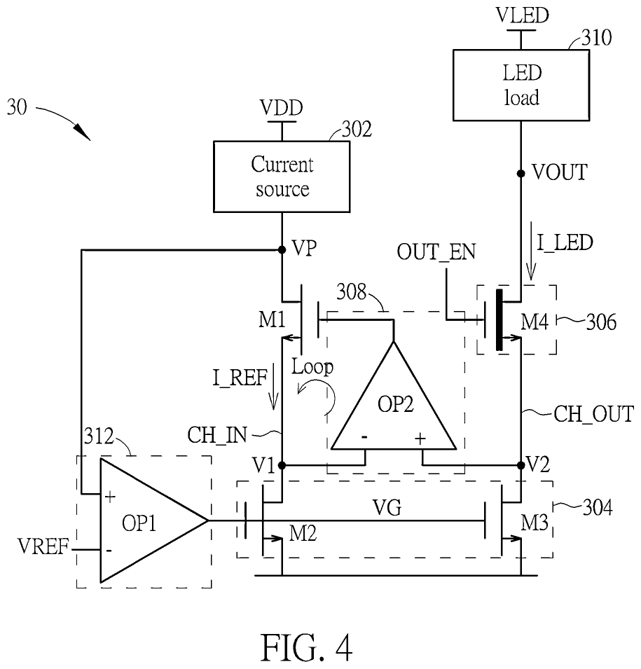

FIG. 4 illustrates a detailed implementation of the current driver 30, which includes the current source 302, transistors M1-M4 and op-amps OP1 and OP2. The current source 302 may generate the reference current I_REF by receiving a power supply voltage VDD. The transistors M2 and M3 are used to realize the current mirror 304. The transistor M4 is used to realize the output enable switch 306 (e.g., by receiving an output enable signal OUT_EN). The transistor M1 is implemented in the input channel CH_IN and coupled between the current source 302 and the current mirror 304, to serve as an input control transistor. In addition, the op-amp OP1 is used to realize the bias generator 312, and the op-amp OP2 is used to realize the control circuit 308.

In detail, the op-amp OP1 is coupled to the drain terminal of the input control transistor M1, to control the level of the drain voltage VP of the transistor M1 according to the reference voltage VREF. More specifically, as shown in FIG. 4, the positive input terminal of the op-amp OP1 is coupled to the drain terminal of the transistor M1, the negative input terminal of the op-amp OP1 is coupled to a reference voltage source to receive the reference voltage VREF, and the output terminal of the op-amp OP1 is coupled to the transistors M2 and M3 of the current mirror 304. With this circuit implementation, the op-amp OP1 may control the voltage VP to be substantially equal to the reference voltage VREF through virtual short-circuit between the input terminals of the op-amp OP1. Note that the voltage VP in the input channel CH_IN cannot be too high, or otherwise the voltage headroom of the current source 302 may be suppressed such that the current source 302 may not be able to operate normally to generate the desired reference current I_REF. In such a situation, the level of the voltage VP may be well controlled through the op-amp OP1 by applying the appropriate reference voltage VREF.

The current mirror 304 may be formed of the transistor M2 in the input channel CH_IN and the transistor M3 in the output channel CH_OUT, to mirror the reference current I_REF in the input channel CH_IN to generate the driving current I_LED in the output channel CH_OUT. In the current mirror 304, the transistors M2 and M3 should have an appropriate width-length (W/L) ratio to mirror the reference current I_REF to generate the desired driving current I_LED. In order to ensure that the current mirror 304 can generate the accurate driving current I_LED, the voltages V1 and V2 at the drain terminal of the transistors M2 and M3 should be equal. The equal voltages V1 and V2 may be realized by using the op-amp OP2.

As shown in FIG. 4, the positive input terminal of the op-amp OP2 is coupled to the output channel CH_OUT, the negative input terminal of the op-amp OP2 is coupled to the input channel CH_IN, and the output terminal of the op-amp OP2 is coupled to the gate terminal of the input control transistor M1. With this circuit implementation, the output terminal and the negative input terminal of the op-amp OP2 along with the transistor M1 will form a feedback loop, to control the voltage V1 of the input channel CH_IN to track the voltage V2 of the output channel CH_OUT.

Different from the two-stage current driver 10 and the three-stage current driver 20 where the feedback loop is formed through the transistor M4 in the output channel CH_OUT, in the embodiments of the present invention, the output terminal of the op-amp OP2 is coupled to the transistor M1 in the input channel CH_IN. In such a situation, the feedback loop of the op-amp OP2 will be formed through the input channel CH_IN, to control the voltage V1 to track the voltage V2. Therefore, the voltage V1 may be approximate to the voltage V2, and the voltage levels of V1 and V2 will be substantially equal when the feedback loop becomes stable. Since the load faced by the feedback loop is associated with the transistor M1 which passes the reference current I_REF, where the transistor M1 may be a low-voltage or mid-voltage device and the reference current I_REF is usually far smaller than the driving current I_LED, the reaction speed of the feedback loop in the current driver 30 will be faster than that in the two-stage current driver 10.

In addition, the transistor M4 is coupled to the output terminal of the current driver 30 for outputting the driving current I_LED, and the output terminal is configured to be coupled to the LED load 310 in the display panel. Therefore, the transistor M4 should be implemented as a high-voltage transistor tolerable to the high power supply voltage VLED of the LED load 310. In this embodiment, the transistor M4 is controlled by receiving the output enable signal OUT_EN, which is a high-speed digital control signal. Therefore, the transistor M4 may be turned on at a fast speed, to allow the current driver 30 to output the driving current I_LED rapidly.

When the transistor M4 is turned on, the LED load 310 starts to flow the driving current I_LED supplied by the current driver 30, allowing the voltage V2 and the output voltage VOUT to fall. The falling speed of these voltages may decrease rapidly due to the limit of the drain-to-source voltage of the transistor M3 when the current mirror 304 is operating. This prevents an overshoot current generated in the output channel CH_OUT. Through the operations of the feedback loop formed by the op-amp OP2, the voltage V1 will track the falling voltage V2 to fall to the same level. Due to the smaller output loading of the op-amp OP2 as its output terminal is coupled to the input channel CH_IN, the feedback loop will make the voltage V1 rapidly reach the level of the voltage V2; that is, the voltage V1 tracks the voltage V2 and becomes stable rapidly. In such a situation, the driving current I_LED will also rapidly reach its target level. When the voltages V1 and V2 reach a lower level, the gate voltage VG may be well controlled to turn on the transistors M2 and M3 to a specific extent, in order to generate a desired driving current I_LED that may equal a desired multiple of the reference current I_REF.

Note that the output voltage VOUT of the current driver 30 may be as low as possible as long as the transistors M2 and M3 can be turned on normally to supply currents, in order to reduce the power consumption of the current driver 30. In an embodiment, the transistors M2 and M3 in the current mirror 304 may be designed to have a large size, so that they are able to supply sufficient currents under a low drain-to-source voltage.

In an embodiment, the driving current I_LED generated by the current mirror 304 is equal to M times the reference current I_REF. This current ratio may be achieved by appropriately designing the width-length ratio of the transistors M2 and M3 to be 1:M, where M may be any positive number.

As can be seen, the load of the op-amp OP2 in the current driver 30 is determined by the transistor M1, which may be a low-voltage device or mid-voltage device having a smaller load. Therefore, the reaction speed of the op-amp OP2 in the current driver 30 will be faster as compared to that in the two-stage current driver 10 as described above; that is, in the current driver 30 of the present invention, the feedback loop of the op-amp OP2 will rapidly become stable and thus the driving current I_LED will rapidly reach its target value. In addition, the current driver 30 of the present invention includes 4 transistors M1-M4, and there is no need to deploy an additional transistor M5. Thus, the current driver 30 is superior to the abovementioned three-stage current driver 20 in the aspect of circuit costs. As a result, the current driver of the present invention possesses the advantages of both the two-stage current driver and the three-stage current driver.

Note that the present invention aims at providing a novel circuit structure of a current driver for supplying a driving current to the LED strings in the display panel. Those skilled in the art may make modifications and alterations accordingly. For example, the current driver of the present invention is applicable to an LED string which may be implemented in the backlight module of an LCD panel. In another embodiment, the LED string that receives currents from the current driver of the present invention may be several LED pixels of a direct view LED panel, such as a mini-LED panel, micro-LED panel, or OLED panel. In general, the LEDs in the backlight module of the LCD panel may be operated under an ultra-high voltage (e.g., up to 60V), where the LED string usually has a great number of LEDs and thus passes a large current, which is accompanied by a larger load that limits the operational speed of the current driver. Therefore, the current driver of the present invention is more advantageous to the applications of the backlight module. However, it should be noted that the current driver of the present invention may supply a driving current to any current-driving device, in order to improve the operational speed of the system. The current-driving device may be any light-emitting device which emits light as being driven by currents, where the application is not limited to the LED strings of the backlight module.

Also note that the circuit structure shown in FIG. 3 is merely an exemplary embodiment of the present invention. Several alterations of the current driver of the present invention are described below.

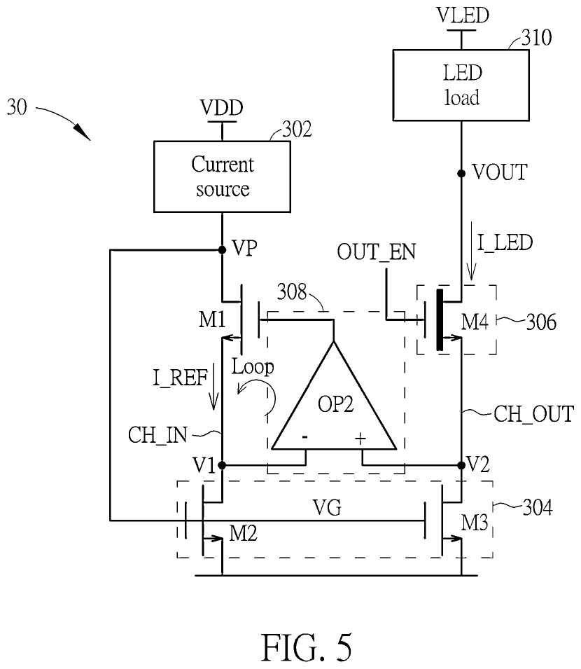

FIG. 5 illustrates another detailed implementation of the current driver 30, which is similar to the circuit structure shown in FIG. 4, so signals and elements having similar functions are denoted by the same symbols. In this embodiment, the op-amp OP1 is omitted, and the drain terminal of the input control transistor M1 (i.e., the current output terminal of the current source 302) is connected to the gate terminal of the transistors M2 and M3. This circuit implementation may be regarded as that the bias generator 312 is omitted, or that the bias generator 312 is implemented with a wire connection between the drain terminal of the transistor M1 and the gate terminal of the transistors M2 and M3. Therefore, the reference voltage for VP may be supplied from the gate voltage VG of the transistor M2 or M3.

As mentioned above, the purpose of the op-amp OP1 is to control the level of the voltage VP at the current output terminal of the current source 302, in order to prevent the headroom of the current source 302 from being suppressed, so that the current source 302 is able to operate normally. The voltage VP may also be controlled without the usage of an op-amp. As shown in FIG. 5, the voltage VP may be clamped to be equal to the gate voltage VG of the transistors M2 and M3. As long as the sizes of the transistors M2 and M3 are well designed to let the gate voltage VG to be always within an appropriate range, the voltage VP will not be excessively high to suppress the current source 302. The circuit implementation shown in FIG. 5 may further achieve the benefit of lower circuit costs since one op-amp is omitted.

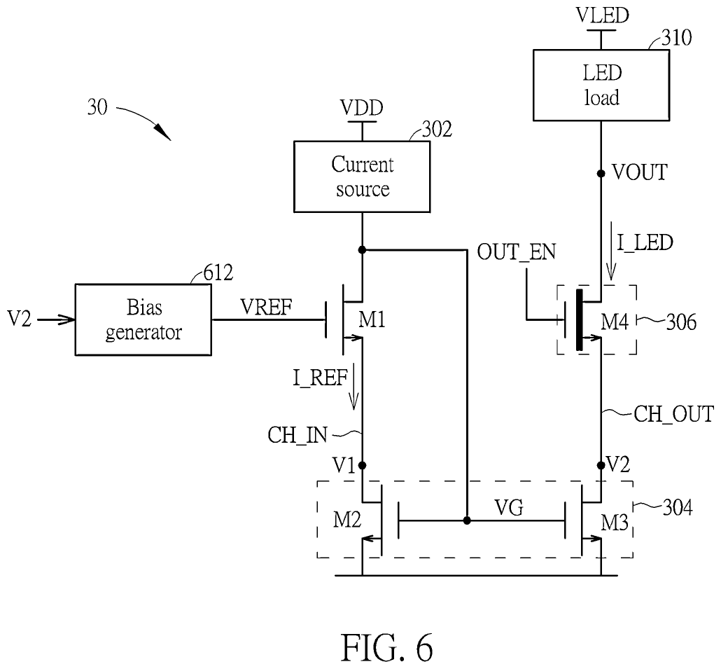

In another embodiment, in order to further simplify the circuit structure and reduce the circuit costs, both the op-amps OP1 and OP2 may be omitted. FIG. 6 illustrates a further detailed implementation of the current driver 30, where no op-amp is included. More specifically, the op-amp OP2 of the control circuit coupled between the input channel CH_IN and the output channel CH_OUT is omitted, or equivalently the control circuit is implemented with a wire connection between the gate terminal of the transistors M2 and M3 and the drain terminal of the input control transistor M1. In addition, the current driver 30 may include a bias generator 612, which may be a voltage source capable of supplying the reference voltage VREF to the input control transistor M1 without the usage of the op-amp OP1.

In an exemplary embodiment, the bias generator 612 may receive the voltage V2 of the output channel CH_OUT, and output the reference voltage VREF to control the voltage V1 according to the voltage V2. In the above embodiments, the drain terminals of the transistors M2 and M3 are coupled to two input terminals of the op-amp OP2, respectively, allowing the voltage V1 to track the voltage V2 and finally equal the voltage V2 through the feedback loop generated from the op-amp OP2. In comparison, in the circuit structure shown in FIG. 6, the bias generator 612 may control the voltage V1 to track the voltage V2 in any appropriate manner such as voltage calibration and/or digital control, which is not limited to the feedback control of an op-amp.

In the above embodiments, the voltage V1 may be controlled to be equal to the voltage V2, so as to generate a desired driving current I_LED through the current mirror 304, where the current amplification ratio of the current mirror 304 may be determined according to the width-length ratio of the transistors M2 and M3. In another embodiment, the voltage V1 of the input channel CH_IN may be controlled to track the voltage V2 of the output channel CH_OUT to let the ratio of the voltage V2 and the voltage V1 is fixed to a specific value, which means that the value V2/V1 is constant. For example, referring back to FIG. 3, the voltages V1 and V2 may be controlled to have a fixed ratio therebetween, and the control circuit 308 may be implemented in any appropriate manner to control the ratio of the voltages V1 and V2. The driving current I_LED may thereby be determined based on the reference current I_REF and also based on the ratio of V2/V1. In this embodiment, the transistors M2 and M3 may be operated in the linear region, and their behavior is equivalent to a resistor; hence, the value of the driving current I_LED may be accurately controlled by using the value V2/V1. In other words, the reference current I_REF may be amplified by a ratio determined based on the value V2/V1 to generate the desired value of the driving current I_LED.

To sum up, the present invention provides a circuit structure of a current driver for outputting currents to drive an LED string. The current driver is composed of a current mirror which may be controlled by an op-amp. The op-amp controls the voltages of the current mirror, to generate an accurate driving current in the output channel based on the reference current in the input channel. The output terminal of the op-amp is coupled to an input control transistor in the input channel and then coupled to the negative input terminal of the op-amp, to form a feedback loop through the input channel. Therefore, the feedback loop will not face a large load of the output transistor (which may be a high-voltage device) at the output terminal of the current driver. This connection method can increase the reaction speed of the feedback loop and thereby increase the operational speed of the current driver outputting the driving current.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A current driver having an input channel and an output channel, comprising:
a current source, deployed in the input channel;
a current mirror, deployed between the input channel and the output channel and coupled to the current source;
an output enable switch, deployed in the output channel and coupled to the current mirror; and
a control circuit, coupled between the input channel and the output channel, to form a feedback loop through the input channel.

2. The current driver of claim 1, wherein the control circuit is configured to control a first voltage of the input channel to track a second voltage of the output channel.

3. The current driver of claim 2, wherein the first voltage is substantially equal to the second voltage.

4. The current driver of claim 2, wherein a ratio of the second voltage and the first voltage is fixed to a specific value.

5. The current driver of claim 1, wherein the current source is configured to generate a reference current in the input channel.

6. The current driver of claim 5, wherein the current mirror is configured to generate a driving current according to the reference current.

7. The current driver of claim 6, wherein the output enable switch is configured to enable an output of the driving current.

8. The current driver of claim 1, wherein the output enable switch comprises a high-voltage transistor.

9. The current driver of claim 1, wherein the current mirror comprises:
a first transistor, deployed in the input channel; and
a second transistor, deployed in the output channel.

10. The current driver of claim 1, further comprising:
an input control transistor, deployed in the input channel and coupled between the current source and the current mirror; and
a bias generator, coupled to the input control transistor.

11. The current driver of claim 10, wherein the bias generator is configured to supply a reference voltage to the input control transistor.

12. The current driver of claim 10, wherein the bias generator comprises:
an operational amplifier, comprising:
a first input terminal, coupled to the input control transistor;
a second input terminal, coupled to a reference voltage source; and
an output terminal, coupled to the current mirror.

13. The current driver of claim 12, wherein the first input terminal of the operational amplifier is coupled to a drain terminal of the input control transistor.

14. The current driver of claim 1, wherein the control circuit comprises an operational amplifier.

15. The current driver of claim 14, wherein the operational amplifier comprises:
a first input terminal, coupled to the output channel;
a second input terminal, coupled to the input channel; and
an output terminal, coupled to the input channel.

16. A current driver having an input channel and an output channel, comprising:
a current source, deployed in the input channel;
an input control transistor, deployed in the input channel and coupled to the current source;
a current mirror, deployed between the input channel and the output channel and coupled to the input control transistor;
an output enable switch, deployed in the output channel and coupled to the current mirror; and
a first operational amplifier, comprising:
a first input terminal, coupled to the output channel;
a second input terminal, coupled to the input channel; and
an output terminal, coupled to the input control transistor.

17. The current driver of claim 16, wherein the first operational amplifier is configured to control a first voltage of the input channel to track a second voltage of the output channel.

18. The current driver of claim 17, wherein the first voltage is substantially equal to the second voltage.

19. The current driver of claim 17, wherein a ratio of the second voltage and the first voltage is fixed to a specific value.

20. The current driver of claim 16, wherein the current source is configured to generate a reference current in the input channel.

21. The current driver of claim 20, wherein the current mirror is configured to generate a driving current according to the reference current.

22. The current driver of claim 21, wherein the output enable switch is configured to enable an output of the driving current.

23. The current driver of claim 16, wherein the output enable switch comprises a high-voltage transistor.

24. The current driver of claim 16, wherein the current mirror comprises:
a first transistor, deployed in the input channel; and
a second transistor, deployed in the output channel.

25. The current driver of claim 16, further comprising:
a bias generator, coupled to the input control transistor.

26. The current driver of claim 25, wherein the bias generator is configured to supply a reference voltage to the input control transistor.

27. The current driver of claim 25, wherein the bias generator comprises:
a second operational amplifier, comprising:
a first input terminal, coupled to the input control transistor;
a second input terminal, coupled to a reference voltage source; and
an output terminal, coupled to the current mirror.

28. The current driver of claim 27, wherein the first input terminal of the second operational amplifier is coupled to a drain terminal of the input control transistor.

29. The current driver of claim 16, wherein the output terminal of the first operational amplifier is coupled to a gate terminal of the input control transistor.

30. The current driver of claim 16, wherein the first operational amplifier forms a feedback loop through the input channel.
